(19) United States
(12) Patent Application Publication
(10) Pub. No.: US 2021/0015214 A1
(43) Pub. Date: Jan. 21, 2021

(54) Improved assembly method in making shoe, and applied correction solution

(71) Applicant: ORISOL TAIWAN LTD., Chang Hwa (CN)

(72) Inventors: Michael LETUCHI, Yavne (IL); Tanya MILLER, Yavne (IL)

(21) Appl. No.: 16/603,586

(22) PCT Filed: Apr. 25, 2017
(86) PCT No.: PCT/CN2017/081801

§ 371 Date: Oct. 8, 2019

(51) Int. Cl. A43D 25/18; A43D 25/20; C09J 175/06; C09J 175/08; C09J 175/12; C08K 5/00

(52) U.S. Cl. CPC A43D 25/18; A43D 25/20; C09J 175/06; C08K 5/0025; C09J 175/12; C08K 5/0016; C09J 175/08

(57) ABSTRACT

An improved assembly method in making a shoe, and an applied correction solution. In the method, according to the porosity or the density of a material to be bonded, correction solutions of different concentrations are added to a TPU binder of a single viscosity, so as achieve the viscosity of the TPU binder, and to overcome the problem of storage and management of various types of binders, and the assembly steps can be simplified.

### BACKGROUND OF THE INVENTION

### Field of the Invention

The present invention relates to a method for manufacturing a shoe, and more particularly to a shoe assembly process. The present invention further relates to a correction solution used in the method for assembling a shoe.

### Related Prior Art

Conventional shoe manufacturing methods usually involve many steps and procedures. One of the methods is to attach the sole made of rubber and EVA (ethylene-vinyl acetate) to the upper (substrate) and bond them together, and the above-mentioned upper can be made of PU (Polyurethane), synthetic leather, leather, mesh-like structures or fabric, etc.

In order to make the bonding between the sole and the upper reliable and secured, continuous pretreatment processes are required to pretreat every component (the sole, the upper) of the shoe, such as: degreasing, polishing, brushing, oven drying, marking and applying binders. The step of applying binders can be applying binders respectively to the sole or the upper alone or applying binders to both the sole and the upper.

The bonding agent for manufacturing shoes is normally PU (polyurethane) which can be presented in various forms, such as solution, binder, hot melt film and hot melt binder powder (TPU—thermoplastic PU).

When the solution and binder are used as solvent/water-based glue, the binder will produce a wet layer with a thickness of about 100-200 microns before drying, and will have a thickness of 20-60 microns after drying. Therefore, when the binder layer applied is relatively thick, it will take a very long time to dry out, and will consume too much energy. On the contrary, when the applied binder layer is relatively thin, it may lead to insufficient adhesion or even failure (the air voids between the surfaces). Based on the above reasons, a single solvent/water-based binder applied to a single surface can not provide sufficient adhesion to shoe parts (sole and upper).

The current solution to the above problem used in the industry is to apply layer of binder or bonding agent both to the sole and the upper simultaneously. In some special circumstances (depending on the properties of the materials), the sole and the upper should be respectively applied with double layers of binder in order to provide an appropriate amount of adhesive.

The good binder agent between the sole and the upper is the bonding agent using TPU (thermoplastic polyurethane) hot melt powder, for example, in the US patent application No. 20140093655 entitled “Method for Applying Hot Melt Binder Powder onto a Shoe or Sole Part” and filed by Orisol company, it discloses the use of TPU hot melt powder as binder.

Powder TPU binder does not have to go through the solvent/water evaporation process due to chemical properties, and it can be applied a single binder layer with a thickness of 100 to 500 microns on one surface only (one side of the sole or the upper). By applying it to the surface of a shoe part by sticky liquid layer or through the conductive liquid, the shoe part can be glued to a base of any 3D shape.

TPU binder is capable of gluing shoe parts of any type (porous or dense materials), and its short activation process is environmentally friendly with no VOC (Volatile organic compounds).

TPU materials have the above-mentioned advantages, but there still be some restrictions, for example:

In order to achieve proper bonding between the sole material (the material coated with TPU binder) and the upper material, it needs to apply priming compositions suitable for different types or various materials of different uppers, each priming composition has a specific viscosity to match the porosity of the to-be-bonded upper shoe part.

For example, the porous uupper substrate (such as mesh) that is easy for glue penetration may require the high viscosity primer (3000-6000 cP) to filling the pores.

The low viscosity (lower than 3000 cP) primer will penetrate to the bottom of the mesh material rather than stay on the top surface and form continuous adhesion, therefore, the high density material may needs to be pretreated with low viscosity primer, so that the solution can penetrate to the pores of the material more easily.

In order to treat different upper materials with different properties, it has to prepare and manage different treatment solutions, which will produce inventory problems and validity issues, resulting in expensive costs.

In the conventional method for assembling shoes, sole and upperall require upper complicated pretreatment, and the specific implementation method is shown in FIG. 1:

The sole must go through the following steps in sequence: a step 51 of sole cleaning, a step 52 of sole priming, a step 53 of coating the sole with sticky liquid, and a step 54 of applying powder.

The upper has to go through the following steps in sequence: a step 61 of cleaning, a step 62 of marking, a step 63 of primer coating, and a step 64 of drying.

After going through the above steps, the upper and the sole then can go through a step 71 of drying and a step 72 of assembling, and the process is very complicated.

The present invention has arisen to mitigate and/or obviate the afore-described disadvantages.

### SUMMARY

One objective of the present invention is to provide an assembly method in making a shoe, which is capable of bonding different kinds of shoe substrate materials by using a single type of TPU binder/bonding agent, so as to overcome the need to store and manage various types of binders.

To achieve the above objective, an assembly method in making provided by the invention comprises the following steps:

a step of cleaning a sole including cleaning a surface of the sole, so that the surface of the sole can be coated with TPU powder;

a step of brushing the sole including applying a primer to a surface of the sole so that the surface of the sole can be coated with TPU powder;

a step of coating sticky liquid to the sole including performing selective coating process to apply sticky or conductive liquid layer;

a step of coating TPU powder to the sole including coating TPU powder to the sticky or conductive liquid layer, so that the TPU powder can be fixed there by the stickiness of the sticky liquid or the electrostatic forces of the conductive liquid layer;

a step of adjustment including applying a correction solution to the TPU powder;

a step of upper cleaning including cleaning a to-be-bonded upper; a step of drying including drying the correction solution and activating the TPU powder by heating; and

a step of assembling includes bonding the sole to the upper by pressing them together.

The invention further provides a correction solution which comprises the following components:

additive amount of 5-90% plasticizer or adjustment solvent;

additive amount of 2-15% crosslinking agent;

additive amount of 0.01˜2% surfactant;

an appropriate additive amount of carrier, the sum of the former three components is equal to 100%.

The assembly method in making using the correction solution in accordance with the invention overcomes the need to store and manage various types of binders, and simplifies the shoe assembling process.

### BRIEF DESCRIPTION OF THE DRAWINGS

FIG. 1 is a flow chart of a conventional method for assembling a rubber sole and the upper;

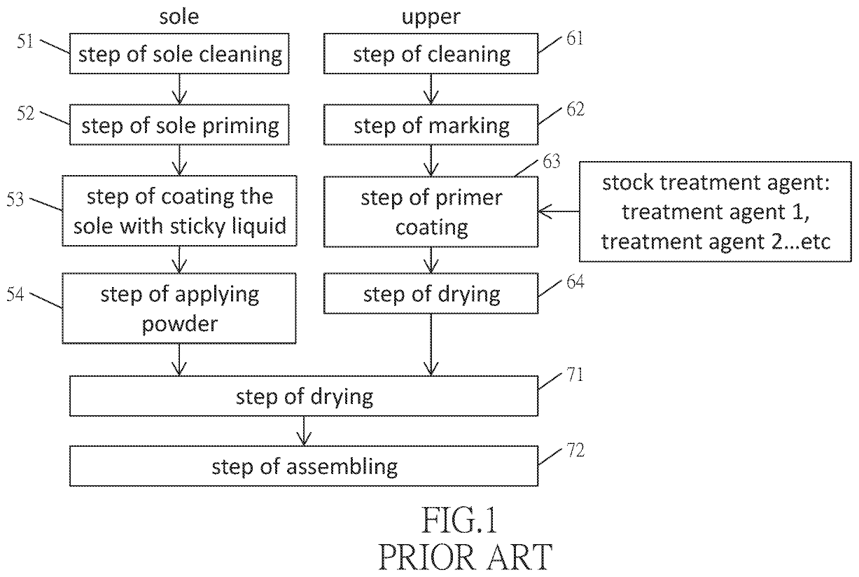

FIG. 2 is a flow chart of a method for assembling a rubber sole and the upper in accordance with a preferred embodiment of the invention;

FIG. 3 is a chart of a method for assembling a rubber sole and the upper in accordance with another preferred embodiment of the invention; and

FIG. 4 shows the compositions of the TPU binder used in the shoe assembling process in accordance with the invention.

### DETAILED DESCRIPTION

The present invention will be clearer from the following description when viewed together with the accompanying drawings, which show, for purpose of illustrations only, the preferred embodiment in accordance with the present invention.

The property of each hot-melt thermoplastic polyurethane (hereinafter referred to as TPU) is determined by the viscosity produced at the activation temperature. The activation temperature is the temperature at which the TPU substance reaches during the bonding process.

The viscosity of the TPU binder applied to the shoe material (which is a sole in this embodiment) must be adjusted according to the porosity of the to-be-bonded shoe material (such as the upper material). The low viscosity melt binder TPU is suitable for coating porous material easy for glue penetration, and the high density material should be coated with high viscosity melt binder TPU (15000-20000 cP).

It should be noted that the porosity or void ratio is a measure of the void volume of the upper, and the ratio of the void volume to the total volume of the porous material is a percentage between 0 to 100%. The size of the pore is important, because smaller pores are more difficult than large pores for the TPU binder to penetrate.

Hard and dense materials usually have inner tensions after attach process and high melt viscous binder TPU is required to prevent delamination of the shoe parts.

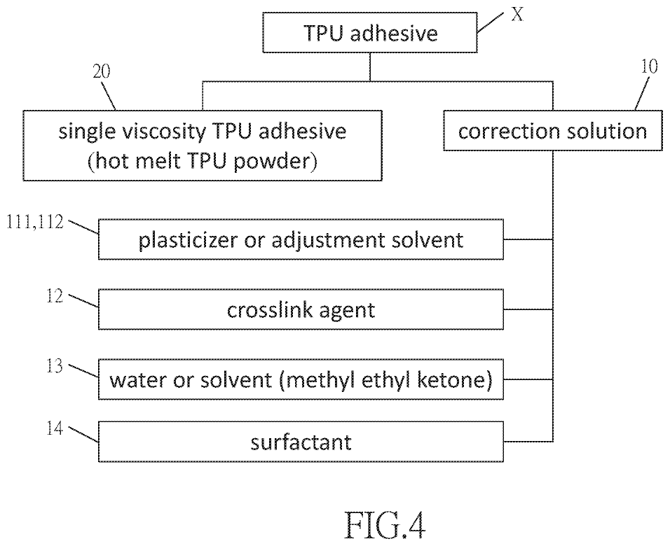

Specific embodiments of the present invention are described as follows (FIG. 4):

The present invention provides a TPU binder viscosity management method by adding a correction solution 10 which includes a plasticizer 111 or an adjustment solvent 112 into a single viscosity TPU binder 20. Preferably, the correction solution 10 containing the adjustment solvent 112 is added, and the single viscosity TPU binder 20 has a relatively high viscosity.

Based on the porosity or density of the to-be-bonded material, the correction solution 10 (including the plasticizer 111 or the adjustment solvent 112) is added to reduce the viscosity of the single viscosity TPU binder 20 to form an adjusted TPU binder X, so that the adjusted TPU binder X has a proper glue penetration property to provide optimal bonding to the shoe parts. Besides, since the binder is mechanically poured into the substrate of the shoe, no priming or filling procedure is required.

Because the amount of the correction solution 10 added to the single viscosity TPU binder 20 is much less than that of the single viscosity TPU binder 20, a carrier 13 becomes indispensable in the standard coating or applying process. Besides, the single viscosity TPU binder 20 with the correction solution 10 has a poor wetting property, therefore, adding a surfactant 14 is the solution to this problem. Based on the correction amount, the adjustment solvent 112/the plasticizer 111 is mixed with a crosslink agent 12 and the carrier 13 to form the correction solution 10. Preferably, the correction solution 10 can further include the surfactant 14.

The present invention discloses that adding the correction solution 10 containing different concentrations of plasticizer 111 or adjustment solvent 112 to a single viscosity TPU binder 20 can produce the adjusted TPU binder X of different viscosities, and the concentrations are determined by the porosity of the to-be-bonded shoe material.

According to the invention, it has to define and choose the single viscosity TPU binder 20 in advance. The single viscosity TPU binder 20 should be preselected as the TPU binder with the highest viscosity and suitable for the most dense (lowest porosity) shoe substrate material during the traditional bonding process. Therefore, based on the porosities of the different shoe substrate materials, different amounts of the plasticizer 111 or the adjustment solvent 112 can be added to the single viscosity TPU binder 20 to form the adjusted TPU binder X which can interact with the shoe substrate material of specific porosities to produce the best bonding effect.

The abovementioned adjustment solvent 112 or the plasticizer 111 can be designed to have different concentrations, so that the resultant adjusted TPU binder X can be applied to various shoe substrate materials, ranging from the shoe substrate material with the lowest porosity (low penetration) to the highest porosity (porous).

The adjustment solvent 112 of the invention includes, but not limited to: cyclohexanone, dimethyl sulfoxide (DMSO) and perchloroethylene and other suitable solvents.

The adjustment solvent 112 has the following limitations:

1. boiling point is higher than 100° C. to prevent the solvent from evaporating before activation.

2. boiling point is lower than 250° C., so that the solvent can evaporate within 48 hours.

3. an environmentally friendly solvent, no danger and no odor.

The adjustment solvent 112 is preferably dimethyl sulfoxide (DMSO).

The correction solution 10 can consist of below four main components, as shown in FIG. 4:

(1). Additive amount of 5˜90% plasticizer 111 or adjustment solvent 112;

(2). Additive amount of 2˜15% crosslink agent 12;

(3) Additive amount of 0.0˜2% surfactant 14;

(4) Appropriate additive amount of carrier 13, the sum of the former four components is equal to 100%, and the carrier 13 can be solvent or water.

An example of the porosity ratio of the materials to the correction solution 10 is given below: the mesh like material has a high porosity of about 80-95%, the porosity of pigskin is about 40%, and the porosity of synthetic PU leather is about 0-20%. In general condition, the ratio of the single viscosity TPU binder 20 (namely, the TPU powder) to the correction solution 10 is 1:0.2˜3.5, wherein ratio 1:0.2 is suitable for low porosity materials (e.g., synthetic leather with 0-20% porosity), ratio 1:3.5 is suitable for high porosity materials (such as mesh material), and the optimum ratio of specific materials requires a series of tests to adjust and obtain different ratios.

The following is an example of the specific correction solution 10, based on water or methyl ethyl ketone (carrier 13):

Preparation 1:

(1) Additive amount of 20% dimethyl sulfoxide (DMSO)

(2) Additive amount of 10% crosslinking agent R490 (Artecola company)

(3) Additive amount of 70% methyl ethyl ketone.

Preparation 2:

(1) Additive amount of 20% dimethyl sulfoxide (DMSO)

(2) Additive amount of 10% crosslinking agent R490 (Artecola company)

(3) Additive amount of 69.9% water

(4) Additive amount of 0.1% fluorine surfactants (Capstone FD-51).

In addition, the single viscosity TPU binder 20 can be TPU powder which can be selected from the products of Lubrizol, BASF, TPUCO, and can also use other TPU powders. The selected TPU powder shall comply with the rules and requirements of shoe assembling processes, and can be added with correction solution to reduce the viscosity of the TPU. The mechanical range from pure TPU to high plasticized TPU should cover all shoe material requirements, and this can be realized through the following limitations:

(1). TPU includes: polyester, polyether, caprolactam, aliphatic and other copolymers.

(2). Hardness: more than 50 A.

(3). Melting Flow Index (MFI): less than 100 g/10 minutes (ASTM D-1238-170 C, 2.16 kg).

(4). The glass transition temperature (Glass Transition Temperature, Tg): lower than −20° C.

(5). The activation temperature: 40˜80° C. (Kofler LA-17 method).

Any methods capable of applying the correction solution 10 to the single viscosity TPU binder 20 is appropriate, this method can be: mix correction solution with the TPU powder or spray or prime it onto the TPU powder layer before being coated or applied to the substrate, or by other methods known in the art. These methods can be implemented manually or automatically.

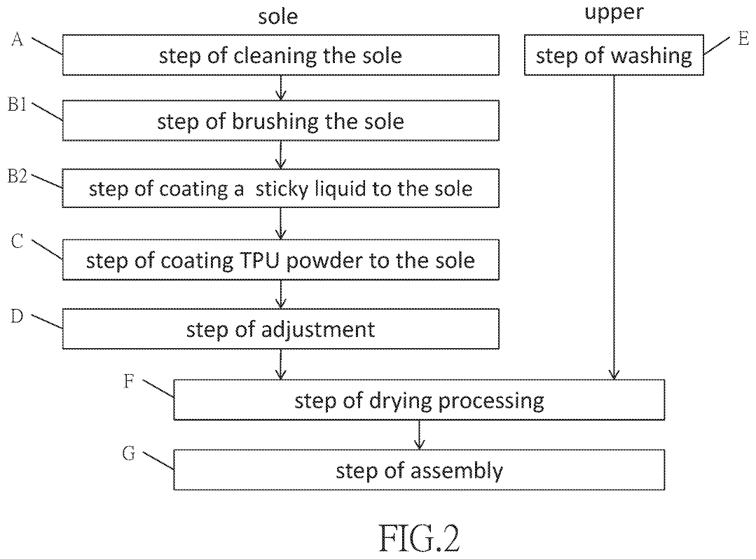

FIG. 2 is a flow chart of the invention showing the assembly method in making the rubber sole (as a substrate material) to the upper (the target material). In this method, only the single viscosity TPU binder 20 is coated to the substrate material, then the correction solution 10 with a specific concentration is used for mixing treatment to obtain the adjusted TPU binder X. The concentration of the adjustment solvent 112 in the correction solution 10 is determined by the to-be-bonded uppers.

The assembly method in making in accordance with the present invention is shown in FIG. 2 and comprises the following steps:

A step A of cleaning a sole includes cleaning a surface of the sole, so that the surface of the sole can be coated with TPU powder;

A step B1 of brushing the sole includes applying a primer so the surface of the sole can be coated with TPU powder;

A step B2 of coating sticky liquid to the sole includes performing selective coating process to apply sticky or conductive liquid layer;

A step C of coating TPU powder to the sole includes coating TPU powder to the sticky or conductive liquid layer, so that the TPU powder can be fixed there by the stickiness of the sticky liquid or the electrostatic forces of the conductive liquid layer;

A step D of adjustment includes applying correction solution to the TPU powder;

A step E of upper cleaning includes cleaning a to-be-bonded upper;

A step F of drying includes drying the correction solution and activating the TPU powder by heating; and

A step G of assembling includes bonding the sole to the upper by pressing them together.

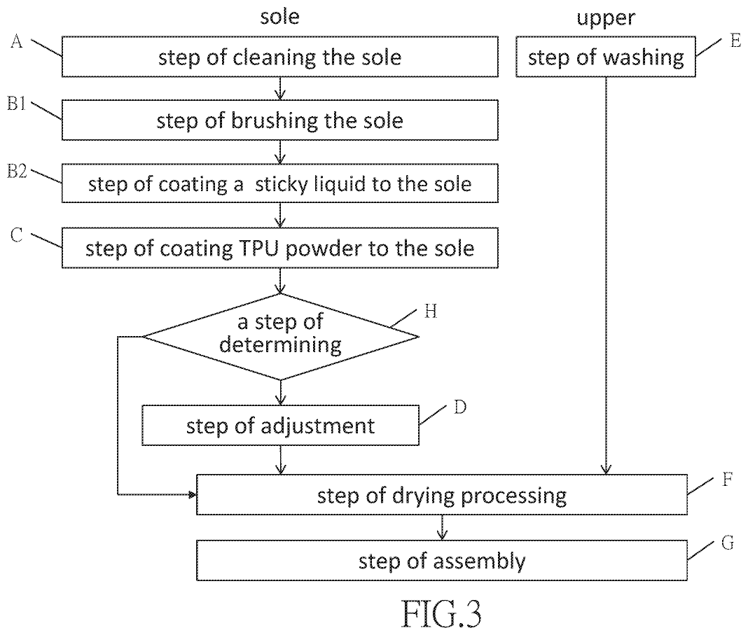

In another embodiment, the shoe assembling method is shown in FIG. 3 and comprises the following steps:

A step A of cleaning a sole includes cleaning a surface of the sole, so that the surface of the sole can be coated with TPU powder;

A step B1 of brushing the sole includes applying a primer to coat the surface of the sole with TPU powder;

A step B2 of coating sticky liquid to the sole includes performing selective coating process to apply sticky or conductive liquid layer;

A step C of coating TPU powder to the sole includes coating TPU powder to the sticky or conductive liquid layer, so that the TPU powder can be fixed there to form a TPU power layer by the stickiness of the sticky liquid or the electrostatic forces of the conductive liquid layer;

A step H of determining includes determining the porosity of the upper material, then determining whether or not to perform an adjustment step D, if yes, then perform the adjustment step D, if not, then perform a step F of drying;

The step D of adjustment includes applying correction solution 10 to the TPU powder layer;

The step F of drying includes drying the correction solution and activating the TPU powder by heating;

A step E of upper cleaning includes cleaning a to-be-bonded upper; and

A step G of assembling includes bonding the sole to the upper by pressing them together.

The following is an example of using different concentrations of adjustment solvent according to different porosity of shoe upper materials, also is the specific implementation of the respective steps:

### Embodiment 1

a) a step B2 of coating sticky liquid to the sole includes coating sticky liquid (dispersion of TPU in water) to the sole (rubber);

b) a step C of coating TPU powder to the sole includes using a machine (model OPS 410, a machine made by Orisol Asia) to apply TPU power with high molecular weight to a sticky liquid, each shoe sole is coated with 3 g TPU (the aforementioned TPU powder with high molecular weight can be the Artepowder 7080 produced by Orisol company);

c) a step F of drying includes heating the TPU powder with high molecular weight on the sole in the oven at 65° C. for 3 minutes and activating it by a flash activator (the surface temperature reaches 90° C.);

d) a step G of assembling includes bonding the sole to the upper made of mesh without any pretreatment process;

e) a step of testing: peeling test is performed 48 hours later, and the peeling test proves a low adhesion between the sole and the upper, the adhesion is between 2-10 N/cm.

### Embodiment 2

a) a step B2 of coating sticky liquid to the sole includes coating sticky liquid (dispersion of TPU in water) to the sole (rubber);

b) a step C of coating TPU powder to the sole includes using a machine (model OPS 410, a machine made by Orisol Asia) to apply TPU power with high molecular weight to a sticky liquid, each shoe sole is coated with 3 g TPU(the aforementioned TPU powder with high molecular weight can be the Artepowder 7080 produced by Orisol company);

c) a step D of adjustment includes applying 3 g correction solution 10 to the TPU powder layer with high molecular weight, and the correction solution 10 is the said preparation 1;

d) a step F of drying includes heating the TPU powder with high molecular weight on the sole in the oven at 65° C. for 3 minutes after the above coating process and activating it by a flash activator (the surface temperature reaches 90° C.);

e) a step G of assembling includes bonding the sole to the upper made of mesh without any pretreatment process;

f) a step of testing: peeling test is performed 48 hours later, and the peeling test proves that the average adhesion between the sole and the upper is 62 N/cm, and 30 N/cm is a test standard for eligibility.

### Embodiment 3

a) a step B2 of coating sticky liquid to the sole includes coating sticky liquid (dispersion of TPU in water) to the sole which is made of a mixture of rubber and EVA (polyethylene vinyl acetate);

b) a step C of coating TPU powder to the sole includes using a machine (model OPS 410, a machine made by Orisol Asia) to apply TPU power with high molecular weight to a sticky liquid, each shoe sole is coated with 3 g TPU(the aforementioned TPU powder with high molecular weight can be the Artepowder 7080 produced by Orisol company);

c) a step D of adjustment includes applying 3 g correction solution 10 to the TPU powder layer with high molecular weight, and the correction solution 10 is the said preparation 1;

d) a step F of drying includes heating the TPU powder with high molecular weight on the sole in the oven at 65° C. for 3 minutes after the above costing process and activating it by a flash activator (the surface temperature reaches 90° C.);

e) a step G of assembling includes bonding the sole to the upper made of artificial leather without any pretreatment process, and a part of the artificial leather is separated immediately from the upper after assembling.

### Embodiment 4

a) a step B2 of coating sticky liquid to the sole includes coating sticky liquid (dispersion of TPU in water) to the sole which is made of a mixture of rubber and EVA (polyethylene vinyl acetate);

b) a step C of coating TPU powder to the sole includes using a machine (model OPS 410, a machine made by Orisol Asia) to apply TPU power with high molecular weight to a sticky liquid, each shoe sole is coated with 3 g TPU (the aforementioned TPU powder with high molecular weight can be the Artepowder 7080 produced by Orisol company);

c) a step D of adjustment includes applying 1.5 g correction solution 10 to the TPU powder layer with high molecular weight, and the correction solution 10 is the said preparation 1;

d) a step F of drying includes heating the powder TPU with high molecular weight on the sole in the oven at 65° C. for 3 minutes after the above coating process and activating it by a flash activator (the surface temperature reaches 90° C.);

e) a step G of assembling includes bonding the sole to the upper made of artificial leather without any pretreatment process, and no separation is found between the upper and the sole;

f) a step of testing: peeling test is performed 48 hours later, and the peeling test proves that the average adhesion between the sole and the upper is 57 N/cm, and 35 N/cm is a test standard for eligibility.

### Embodiment 5

a) a step B2 of coating sticky liquid to the sole includes coating sticky liquid (dispersion of TPU in water) to the sole made of rubber;

b) a step C of coating TPU powder to the sole includes using a machine (model OPS 410, a machine made by Orisol Asia) to apply TPU power with high molecular weight to a sticky liquid, each shoe sole is coated with 3 g TPU(the aforementioned TPU powder with high molecular weight can be the Artepowder 7080 produced by Orisol company);

c) a step D of adjustment includes applying 3 g correction solution 10 to the TPU powder layer with high molecular weight, and the correction solution 10 is the said preparation 2;

d) a step F of drying includes heating the powder TPU with high molecular weight on the sole in the oven at 65° C. for 3 minutes after the above coating process and activating it by a flash activator (the surface temperature reaches 90° C.);

e) a step G of assembling includes bonding the sole to the upper made of mesh without any pretreatment process;

f) a step of testing: peeling test is performed 48 hours later, and the peeling test proves that the average adhesion between the mesh made sole and the upper is 45 N/cm, and 30 N/cm is a test standard for eligibility.

### MARKS IN CONVENTIONAL DRAWING

51: step of sole cleaning

52: step of sole priming

53: step of coating the sole with sticky liquids

54: step of applying powder.

61: step of cleaning

62: step of marking

63: step of coating with primers

64: step of drying

71: step of drying

72: step of assembling

### MARKS IN PRESENT APPLICATION

A: step of cleaning a sole

B1: step of brushing the sole

B2: step of coating stickyliquids on the sole

C: step of coating TPU powder on the sole

D: step of adjustment

E: step of washing

F: step of drying

G: step of assembling

H: step of determination

10: correction solution

20: single viscosity TPU binder

111: plasticizer

112: adjustment solvent

12: crosslink agent

13: carrier

14: surfactant

X: TPU binder

1. An assembly method in making a shoe comprising the following steps:
a step of cleaning a sole including cleaning a surface of the sole, so that the surface of the shoe part can be coated with a TPU powder;
a step of brushing the sole including applying a primer so the surface of the sole can be coated with the TPU powder;
a step of coating sticky liquid to the sole including performing selective coating process to apply a sticky or conductive liquid layer;
a step of applying the TPU powder to the sole including applying the TPU powder to the sticky or conductive liquid layer, so that the TPU powder can be fixed there to form a powder layer by the stickiness of the sticky liquid or the electrostatic forces of the conductive liquid layer;
a step of adjustment including applying a correction solution to the powder layer;
a step of washing including cleaning a to-be-bonded upper;
a step of drying including drying the correction solution and activating the TPU powder by heating; and
a step of assembling includes bonding the sole to the upper by pressing them together.

2. The method as claimed in claim 1 wherein a ratio of the TPU powder to the correction solution is 1:0.2˜1:3.5.

3. The method as claimed in claim 1, wherein the correction solution includes a plasticizer or an adjustment solvent.

4. The method as claimed in claim 1 wherein the correction solution is sprayed and coated onto the powder layer.

5. The method as claimed in claim 1, wherein the correction solution is brushed to the powder layer.

6. The method as claimed in claim 1, wherein the TPU powder has the following characteristics:
(1). TPU type includes: polyester, polyether, caprolactam, aliphatic and other copolymers;
(2). Hardness: more than 50 A;
(3). The Melt Flow Index (MFI): less than 100 g/10 minutes (ASTM D-1238-170 C, 2.16 kg);
(4). The glass transition temperature (glass transition temperature, Tg): lower than −20° C.;
(5). The activation temperature: 40˜80° C. (Kofler LA-17 method).

7. The method as claimed in claim 3, wherein the adjustment solvent has the following characteristics:
1). boiling point is higher than 100° C.
2). boiling point is lower than 250° C.
3). with good polyurethane dissolving ability.

8. The method as claimed in claim 1, wherein the correction solution is based on water or methyl ethyl ketone.

9. The method as claimed in claim 1 is suitable for inventory assembly and shoe assembling or making.

10. An assembly method in making a shoe comprising the following steps:
a step of cleaning a sole including cleaning a surface of the sole, so that the surface of the sole can be coated with a TPU powder;
a step of brushing the sole including applying a primer so the surface of the sole can be coated with the TPU powder;
a step of coating sticky liquid to the sole including performing selective coating process to apply a sticky or conductive liquid layer;
a step of applying the TPU powder to the sole including applying the TPU powder to the sticky or conductive liquid layer, so that the TPU powder can be fixed there to form a powder layer by the viscidity of the sticky liquid or the static of the conductive liquid layer;
a step of determining including determining a porosity of a upper material, then determining whether or not to perform an adjustment step, if yes, then perform the adjustment step, if not, then perform a step of drying;
the step of adjustment including applying a correction solution to the powder layer;
the step of drying including activating the TPU powder by heating;
a step of washing including cleaning a to-be-bonded upper; and
a step of assembling including bonding the sole to the upper by pressing them together.

11. A correction solution comprising the following components:
additive amount of 5˜90% plasticizer or adjustment solvent;
additive amount of 2˜15% crosslinking agent;
appropriate additive amount of carrier, the sum of the former three components is equal to 100%.

12. A correction solution comprising the following components:
additive amount of 5˜90% plasticizer or adjustment solvent;
additive amount of 2˜15% crosslinking agent;
additive amount of 0.01˜2% surfactant;
appropriate additive amount of carrier, the sum of the former four components is equal to 100%.

13. The correction solution as claimed in claim 11 or 12, wherein the carrier is solvent or water.

14. The correction solution as claimed in claim 11 or 12, wherein the adjustment solvent is dimethyl sulfoxide (DMSO).
